(19) United States
(12) Patent Application Publication
(10) Pub. No.: US 2013/0297341 A1
(43) Pub. Date: Nov. 7, 2013

(54) AGGREGATION OF DATA FROM THIRD PARTY ELECTRONIC MEDICAL OR HEALTH RECORDS SYSTEMS INTO A PERSONAL HEALTH RECORD ACCOUNT

(71) Applicant: Ingrid G. Safranek, Los Angeles, CA (US)

(72) Inventor: Ingrid G. Safranek, Los Angeles, CA (US)

(73) Assignee: MYMEDICALRECORDS.COM, INC., Los Angeles, CA (US)

(21) Appl. No.: 13/461,219

(22) Filed: May 1, 2012

(51) Int. Cl. G06Q 50/24

(52) U.S. Cl. 705/3

(57) ABSTRACT

A method for managing health care records to consolidate health care records of an individual within a primary personal health record portal is provided. The method includes acquiring user id and password information from a user for a secondary personal health record portal containing health records of the user, automatically accessing the secondary personal health record portal by a computing device associated with the primary health record portal by using the user id and password information for the secondary personal health record portal, following a script for the secondary personal health record portal to access the health records of the user on the secondary personal health record portal, and transferring the health records of the user from the secondary personal health record portal to the primary personal health record portal.

### FIELD OF THE INVENTION

The present invention relates to personal health records. More particularly, but not exclusively, the present invention relates to a method and system for aggregating personal health records.

### BACKGROUND OF THE INVENTION

Although it is generally recognized that it is beneficial to an individual to have access to their personal health records, problems remain. One of the problems is that different health care providers may use different electronic medical record (EMR) and electronic health record (EHR) systems. Thus, there are problems in being able to aggregate personal health records all in one place where an individual uses multiple different health care providers who use different systems.

In addition, sometimes it is inconvenient to manually enter health care records into an account or to request health care records from each health care provider. Thus, for this reason, an individual does not maintain all of their current personal health care records in a single location.

What is needed is an improved way to aggregate personal health records.

### SUMMARY OF THE INVENTION

Therefore it is a primary object, feature, or advantage of the present invention to improve over the state of the art.

It is a further object, feature, or advantage of the present invention to provide the ability to aggregate all of an individual's health-related records in a single system.

It is a still further object, feature, or advantage of the present invention to provide the ability to change settings associated with a plurality of different online portals to facilitate data collection at a single portal.

Another object, feature, or advantage of the present invention is to manage the use of a plurality of different online portals from a single portal.

One or more of these and/or other objects, features, or advantages of the present invention will become clear from the specification and claims that follow. No single embodiment of the present invention need achieve each and every object, feature, or advantage described here. It is contemplated that different embodiments of the present invention may achieve different objects, features, or advantages.

According to one aspect of the present invention, a method for managing health care records to consolidate health care records of an individual within a primary personal health record portal is provided. The method includes acquiring user id and password information from a user for a plurality of secondary personal health record portals containing health records of the user, automatically accessing each of the plurality of secondary personal health record portals through a computing device associated with the primary personal health record portal by using the user id and password information, following a script for each of the plurality of secondary personal health record portals to access the health records of the user on each of the plurality of secondary personal health record portals, and transferring the health records of the user from each of the plurality of secondary health record portals over a network to the primary personal health record portal.

According to another aspect of the present invention, an apparatus for managing health care records to consolidate health care records of an individual within a primary health record portal is provided. The apparatus includes a computing device operatively connected through a network to a plurality of secondary health record portals. The computing device programmed to (a) acquire user id and password information from a user for the plurality of secondary personal health record portals, (b) automatically access each of the plurality of secondary health record portals using the user id and password information, (c) follow a script for each of the plurality of secondary health record portals to access the health records of the user on each of the plurality of secondary health record portals, and (e) transfer the health records of the user from each of the plurality of secondary health record portals to the computing device.

According to another aspect of the present invention, a method for managing health care records to consolidate health care records of an individual within a primary personal health record portal is provided. The method includes acquiring user id and password information from a user for a secondary personal health record portal containing health records of the user, automatically accessing the secondary personal health record portal by a computing device associated with the primary health record portal by using the user id and password information for the secondary personal health record portal, following a script for the secondary personal health record portal to access the health records of the user on the secondary personal health record portal, and transferring the health records of the user from the secondary personal health record portal to the primary personal health record portal.

According to another aspect of the present invention, a method for managing health care records to consolidate health care records of an individual within a primary personal health record portal is provided. The method includes acquiring user id and password information from a user for a plurality of health information technology systems containing health records of the user. The method further includes automatically accessing each of the plurality of health information technology systems through a computing device associated with the primary personal health record portal by using the user id and password information. The method further includes following a script for each of the plurality of health information technology systems to access the health records of the user on each of the plurality of health information technology systems. The method further includes transferring the health records of the user from each of the plurality of health information technology systems over a network to the primary personal health record portal.

### BRIEF DESCRIPTION OF THE DRAWINGS

FIG. 1 is a block diagram illustrating a primary personal health record portal which may aggregated personal health records from remote health information technology systems.

FIG. 2 is a block diagram illustrating communication between a primary personal health record portal and remote health information technology systems/secondary personal health record portals.

FIG. 3 illustrates one example of a screen display associated with the primary personal health record portal which allows access information such as login id and password to be specified for each secondary personal health record portal.

FIG. 4 illustrates one example of a screen display which allows preferences for a secondary personal health record portal to be specified with the primary personal health record portal.

FIG. 5 is a block diagram illustrating one example of a method.

### DETAILED DESCRIPTION OF THE PREFERRED EMBODIMENTS

The present invention allows a user of a PHR portal to log-in into third party systems from the PHR portal to pull and aggregate personal health records from the third party systems. For purposes here, the personal health record portal is generally referred to as the primary personal health record portal. The other third party systems which are accessed through the primary personal health record portal may be referred to as health information technology remote systems or secondary personal health record portals.

It is contemplated that an individual may have online access to different subsets of their personal health records through different online systems. For example, different health care providers may offer some form of access to health records of the individual which are generated by the health care provider. This type of system is sometimes called a tethered solution because the individual only has access to those records which are available through (or tethered to) the particular health care provider. In addition, insurers may provide their own version of personal health record portals where they make claims related data available.

In operation, user id, password, and other access information may be provided for each service used by the individual. Examples of other types of access information may include challenge questions and answers or other personal information which may be requested by the systems in order to allow access.

It is contemplated that the system may then follow an automated script for each service which is automatically logged into. Preferably, the script allow for records to be obtained from each service and transferred to the PHR portal.

In addition to providing for obtaining access to the health records on the various different portals, the present invention provides for managing settings associated with the various different portals in a manner which assists in facilitating use of the primary PHR portal.

For example, the scripts may update contact information for each of the various different portals to include phone numbers, fax numbers, or other destination addresses associated with the primary PHR portal.

In one embodiment, users of the primary PHR portal have a LIFELINE number. The LIFELINE number may be dedicated phone number associated with the user account of the user. Thus, voicemails may be securely sent to the user's account through use of the dedicated phone number. In addition, faxes may be securely sent to the user's account through use of the dedicated phone number.

As part of the script, the phone number and/or fax number of the user may be updated on each of the various different portals to refer to the dedicated phone number. Thus, further communications with each health care provider may be facilitated in a manner that further facilitates aggregating of personal health records of a user at a single location.

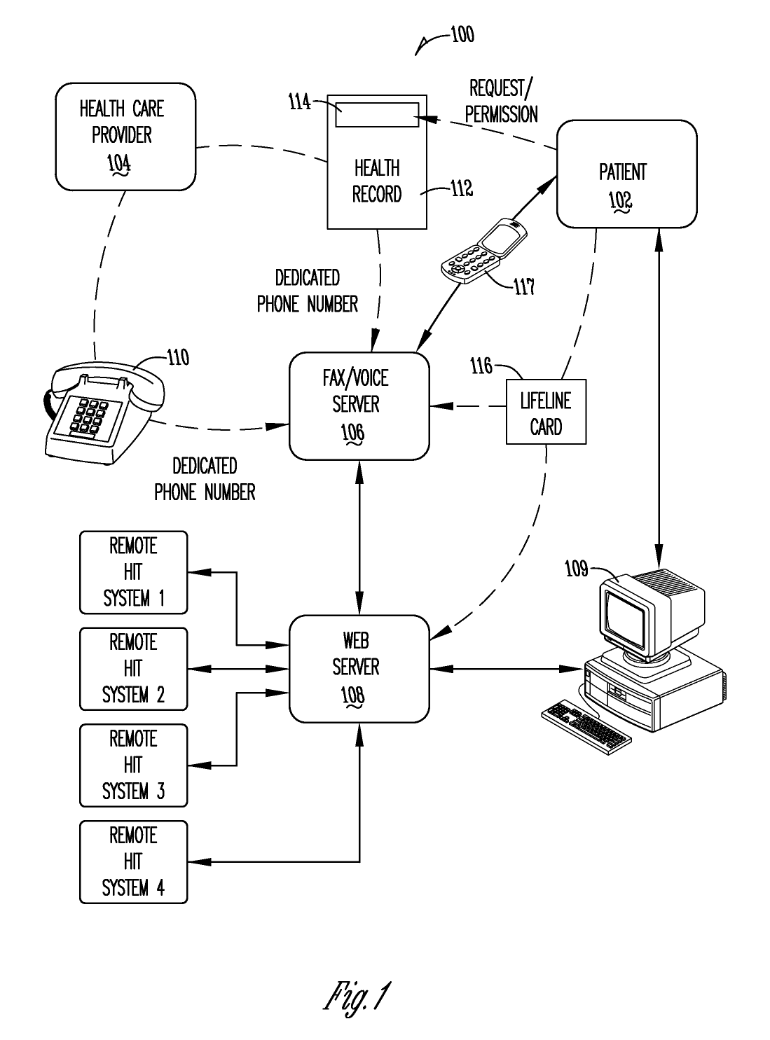

FIG. 1 illustrates one example of a system 100 associated with a personal health record portal which allows for collection and aggregation of personal health records in a manner which allows a user to control and manage their own personal health records. As shown in FIG. 1 a patient 102 or user may request permission from one or more health care providers 104 for their health records 112 to be sent to a destination address which may, for example, be a dedicated phone number associated with a fax/voice server 106. The permission 114 may be in the form of a sticker 114, fax cover sheet, or other paper or electronic document. Thus, faxes of personal health records may be sent by the health care provider 104 to the dedicated phone number and images of the personal health records may then be stored and associated with the user account of the patient 102. Similarly, the health care provider 104 may call the dedicated phone number and leave voicemail messages which are associated with the user account of the patient 102. A lifeline card 116 may be used by the patient 102 and may include the dedicated phone number and access information to access the personal health record portal.

The present invention provides for communicates from the personal health record portal 100 to one or more remote health information technology systems 130, 132, 134, 136. The remote health information technology systems may be other personal health record portals, including, but not limited to systems which are tethered to particular health care providers, particular insurance providers, or other systems.

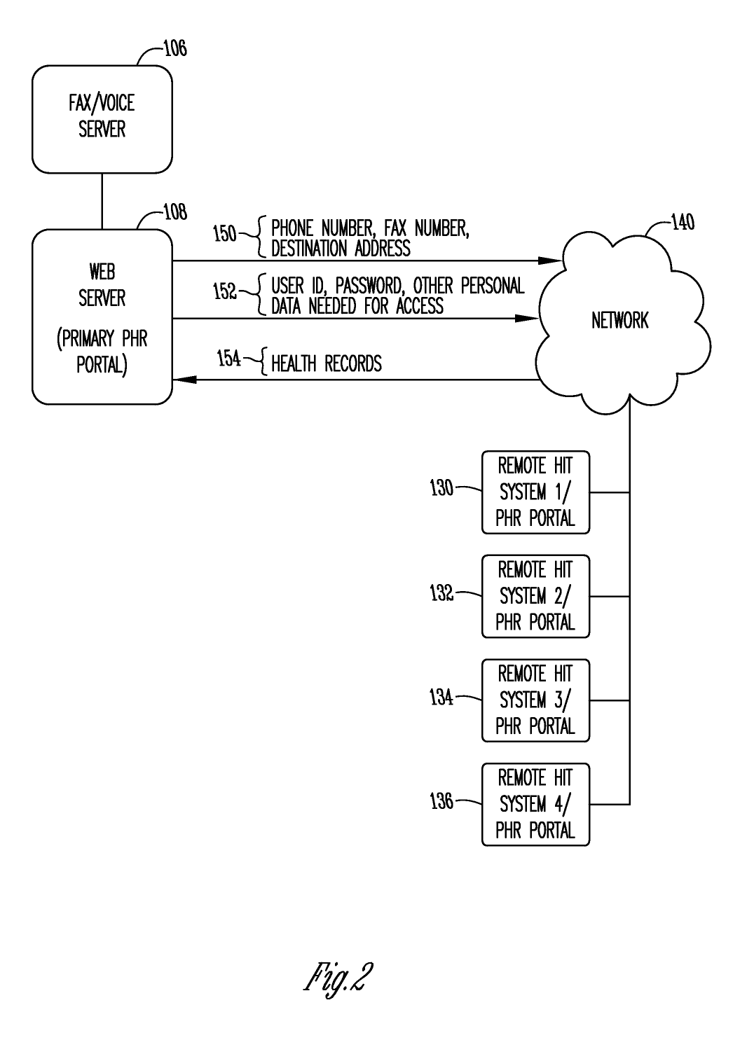

FIG. 2 illustrates in more detail communication over a network 140 between the web server 108 associated with the personal health record portal 100 and remote health information technology systems or personal health record portals 130, 132, 134, 136. As shown in FIG. 2, the web server 108 may communicate access information such as a user id, password, and/or other access information 152 over the network to access each of the remote systems 130, 132, 134, 136. It is contemplated that in addition to user id, password, or other information such as challenge questions and answers may be needed to access the other systems, or other information which may be required where more complex security is used. Once access is provided to one of the remote systems 130, 132, 134, 136, a script may be followed to access health records 154 and convey the health records 154 to the web server 108 where the health records are stored in the user account. This process may be repeated for each of the remote systems or personal health record portals 130, 132, 134, 136. Thus, in this manner personal health records from a plurality of different personal health record portals may be aggregated into a single personal health record system.

In addition, the present invention contemplates that settings or preferences 150 may be made or updated for each of the remote systems or personal health record portals 130, 132, 134, 136. For example, the phone number of a user may be updated to be the dedicated lifeline number of the user. Similarly, the fax number of a user may be updated to be the dedicated lifeline number of the user. Alternatively, an email address or other destination address of the user may be updated to be an email address or destination address associated with the user's account on the single personal health record system.

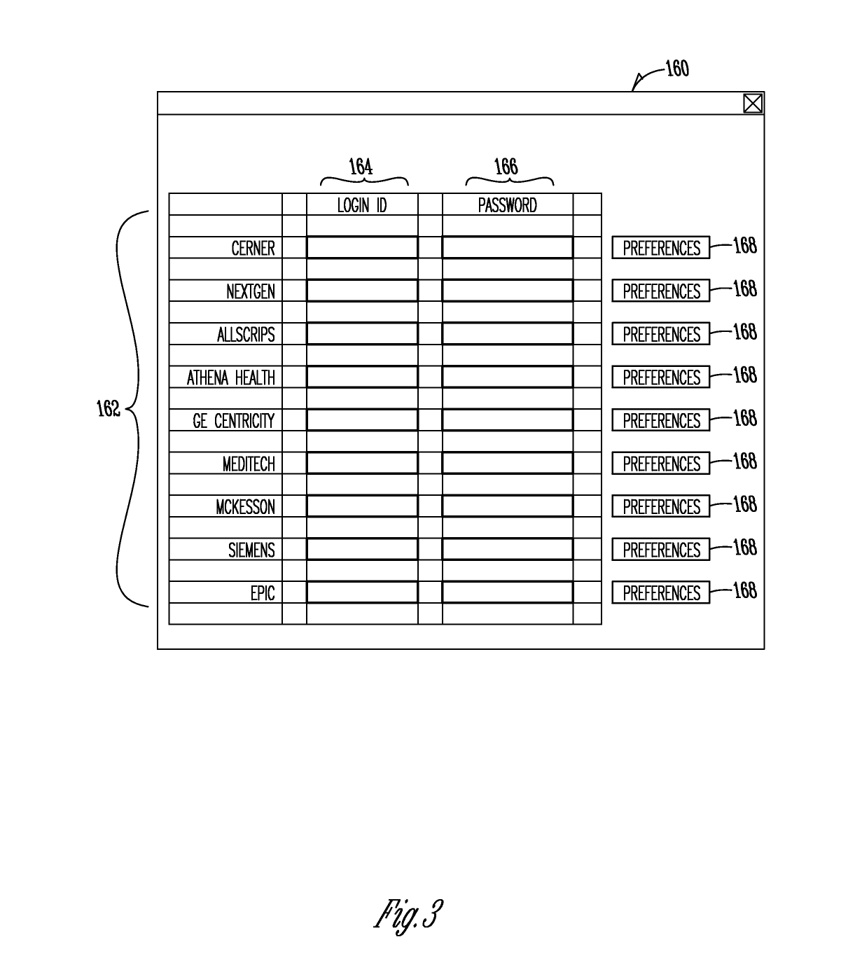

FIG. 3 illustrates one example of a screen display 160 which may be used by the personal health record system. A number of secondary personal health record portals 162 are provided and the user can enter their user id or login id 164 and password 166. In addition, the user may select the preferences button 168 to set additional preferences for each of the different personal health record portals.

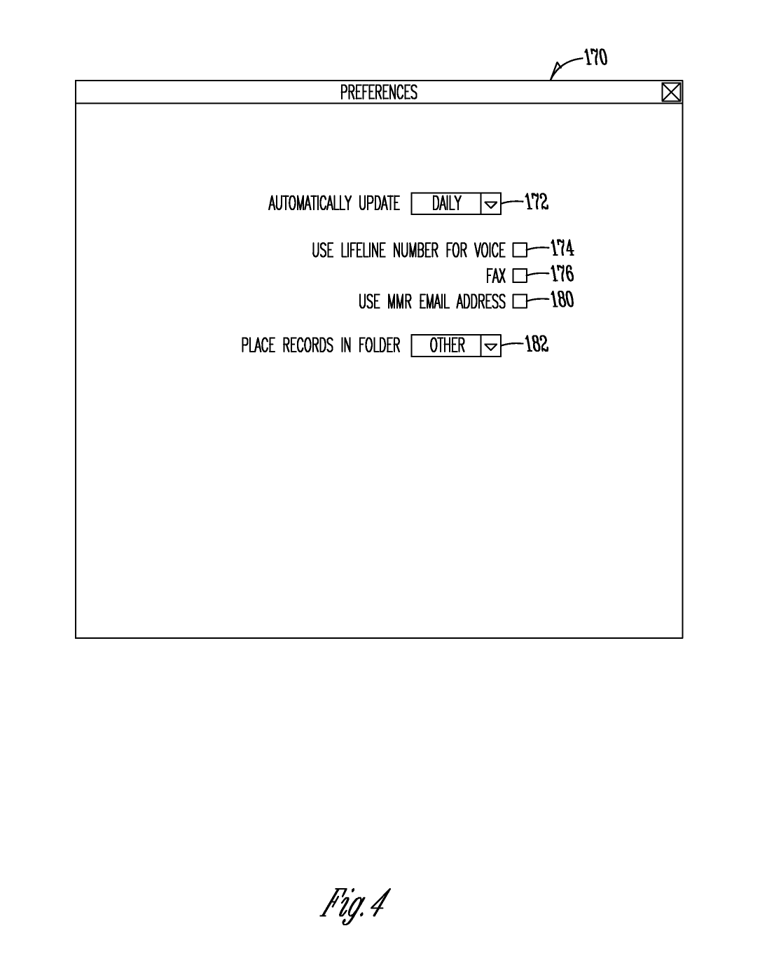

FIG. 4 is a screen display 170 which illustrates examples of preferences which may be set by a user. For example, the user can select whether or not to automatically access the personal health record portal and how often to do so. For example, the personal health record portal could be automatically accessed and updated records received daily, weekly, monthly, or at other periodic intervals. In addition, the user may select whether their dedicated phone number from their primary personal health record portal should be used as the voice and/or fax number on the secondary personal health record portal. Similarly, the user may select whether their email address from their primary personal health record portal or other destination address from their primary personal health record portal should be used on the secondary personal health record portal. Another example of a preference which may be set is to specify a particular folder associated with their user account that records from the secondary personal health record portal may be placed within.

It is to be understood that in addition to the specific preferences shown, the present invention contemplates that additional preferences may be included which may be associated with the available functions from either the secondary personal health record portal or the primary personal health record portal.

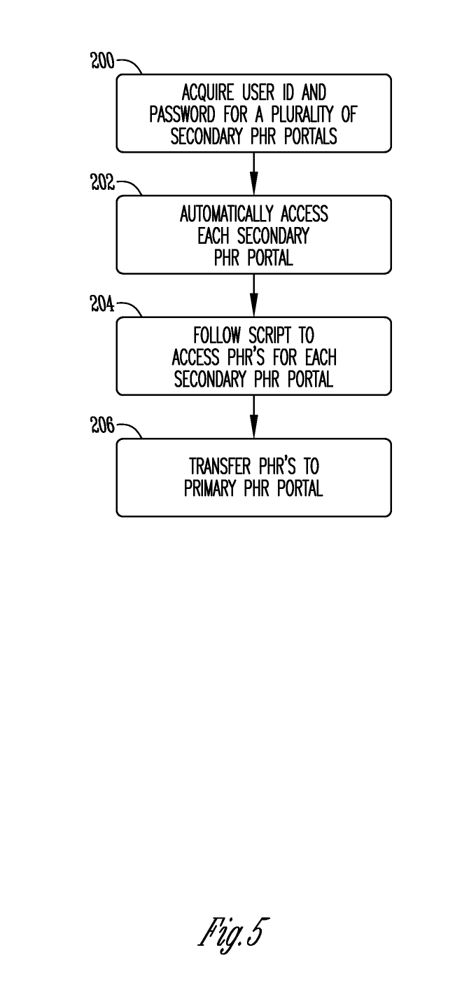

FIG. 5 is a block diagram illustrating one example of the methodology which may be used. In step 200, the primary personal health record portal acquires the necessary user id and password or other login information for one or more secondary personal health record portals. In step 202, the primary personal health record portal automatically accesses each of the secondary personal health record portals. In step 204, a script is followed for each of the secondary personal health record portals to obtain the personal health records. In step 206, the personal health records from each of the secondary personal health record portals are transferred to the primary personal health record portal. Each script may be customized to accommodate the secondary personal health record portal and its operations.

Although specific embodiments and examples are given herein, the present invention contemplates numerous options, variations, and alternatives. The present invention is not to be limited to the specific examples provided herein.

What is claimed is:

1. A method for managing health care records to consolidate health care records of an individual within a primary personal health record portal, the method comprising:
(a) acquiring user id and password information from a user for a plurality of secondary personal health record portals containing health records of the user;
(b) automatically accessing each of the plurality of secondary personal health record portals through a computing device associated with the primary personal health record portal by using the user id and password information;
(c) following a script for each of the plurality of secondary personal health record portals to access the health records of the user on each of the plurality of secondary personal health record portals; and
(d) transferring the health records of the user from each of the plurality of secondary health record portals over a network to the primary personal health record portal.

2. The method of claim 1 further comprising periodically repeating steps (b) through (d) to obtain new or updated health records from the plurality of secondary personal health record portals.

3. The method of claim 1 further comprising managing settings of each of the plurality of secondary personal health record portals to change a phone number associated with the individual to a phone number associated with a user account of the individual associated with the primary personal health record portal.

4. The method of claim 1 further comprising managing settings of each of the plurality of secondary personal health record portals to change a fax number associated with the individual to a fax number associated with the primary personal health record portal.

5. The method of claim 1 further comprising managing settings of each of the plurality of secondary health record portals to request health records be directly communicated to a destination address associated with the primary personal health record portal.

6. The method of claim 5 wherein the destination address is an email address.

7. The method of claim 5 wherein the destination address is a fax number.

8. The method of claim 1 further comprising following the script for each of the plurality of secondary personal health record portals to manage the use of each of the plurality of secondary personal health record portals.

9. An apparatus for managing health care records to consolidate health care records of an individual within a primary health record portal, the apparatus comprising:
a computing device operatively connected through a network to a plurality of secondary health record portals;
the computing device programmed to (a) acquire user id and password information from a user for the plurality of secondary personal health record portals, (b) automatically access each of the plurality of secondary health record portals using the user id and password information, (c) follow a script for each of the plurality of secondary health record portals to access the health records of the user on each of the plurality of secondary health record portals, and (e) transfer the health records of the user from each of the plurality of secondary health record portals to the computing device.

10. The apparatus of claim 9 wherein the computing device is further programmed to periodically repeat steps (b) through (d) to obtain new or updated health records from the plurality of secondary health record portals.

11. The apparatus of claim 9 wherein the computing device is further programmed to construct the script based on preferences set by the user.

12. The apparatus of claim 10 wherein the preferences include a phone number associated with the primary health record portal to facilitate voice communications from the health care provider to the phone number.

13. The apparatus of claim 10 wherein the preference include method of claim 1 further comprising managing settings of each of the plurality of secondary health record portals to change a fax number associated with the individual to a fax number associated with the primary health record portal.

14. The method of claim 1 further comprising managing settings of each of the plurality of secondary health record portals to request health records be directly communicated to a destination address associated with the primary health record portal.

15. The method of claim 14 wherein the destination address is an email address.

16. The method of claim 14 wherein the destination address is a fax number.

17. The method of claim 9 further comprising following the script for each of the plurality of secondary health record portals to manage the use of each of the plurality of secondary health record portals.

18. A method for managing health care records to consolidate health care records of an individual within a primary personal health record portal, the method comprising:
(a) acquiring user id and password information from a user for a secondary personal health record portal containing health records of the user;
(b) automatically accessing the secondary personal health record portal by a computing device associated with the primary health record portal by using the user id and password information for the secondary personal health record portal;
(c) following a script for the secondary personal health record portal to access the health records of the user on the secondary personal health record portal; and
(d) transferring the health records of the user from the secondary personal health record portal to the primary personal health record portal.

19. The method of claim 18 further comprising periodically repeating steps (b) through (d) to obtain new or updated health records from the secondary personal health record portal.

20. The method of claim 18 further comprising managing settings of the secondary personal health record portal from the primary personal health record portal to change a phone number associated with the individual to a phone number associated with a user account of the individual on the primary personal health record portal.

21. The method of claim 18 further comprising managing settings of the secondary personal health record portal to change a fax number associated with the individual to a fax number associated with a user account on the primary personal health record portal.

22. The method of claim 18 further comprising managing settings of the secondary personal health record portal to request health records be directly communicated to a destination address associated with a user account on the primary personal health record portal.

23. A method for managing health care records to consolidate health care records of an individual within a primary personal health record portal, the method comprising:
(a) acquiring user id and password information from a user for a plurality of health information technology systems containing health records of the user;
(b) automatically accessing each of the plurality of health information technology systems through a computing device associated with the primary personal health record portal by using the user id and password information;
(c) following a script for each of the plurality of health information technology systems to access the health records of the user on each of the plurality of health information technology systems; and
(d) transferring the health records of the user from each of the plurality of health information technology systems over a network to the primary personal health record portal.
